(19) United States
(12) Patent Application Publication
(10) Pub. No.: US 2004/0214147 A1
(43) Pub. Date: Oct. 28, 2004

(54) Methods and apparatus for teaching an individual to hit a projectile

(76) Inventor: Steven Jay Robinson, St. Louis, MO (US)

Correspondence Address: John S. Beulick, Armstrong Teasdale LLP, Suite 2600, One Metropolitan Sq., St. Louis, MO, 63102, US

(21) Appl. No.: 10/277,947

(22) Filed: Oct. 21, 2002

(51) Int. Cl. G09B 9/00; G09B 19/00; A63B 69/00

(52) U.S. Cl. 434/247

(57) ABSTRACT

A protective helmet configured to be worn by a user is provided. The helmet includes a domed shell, a visor, and at least one blinder. The visor extends forwardly from the shell. The at least one blinder includes an upper edge, a lower edge, and a body extending therebetween. The blinder is coupled to the shell such that the blinder upper edge is between the visor and the blinder lower edge. The blinder body obstructs vision of the user between the visor and the blinder lower edge.

### BACKGROUND OF THE INVENTION

This application relates generally to sports equipment and, more particularly, to methods and apparatus for teaching an individual to hit a projectile.

The game of baseball has been loved and enthusiastically supported for over 150 years. It remains one of America's favorite sports. Baseball and/or sports derived from baseball, such as softball, have become increasingly popular abroad and amongst younger children and athletes.

Hitting a substantially spherical projectile, such as a baseball or a softball, with an object that has a substantially circular cross-sectional profile, such as a baseball bat, can be a formidable task that requires a great deal of eye-hand coordination. More specifically, in a confrontation between a good pitcher and a good batter, the pitcher is considered to have a definite advantage, which may explain why most hitters get base hits less than 30% of the time, i.e., a 0.300 batting average. In fact, only a few great hitters in the history of professional baseball have ever managed to complete a season with a batting average of 0.400 or greater.

Over the years, to facilitate improving the odds of a batter making contact with the ball, many various batting methods and styles have been developed. Although many batting styles have been developed and taught, one concept that is relentlessly emphasized by almost every experienced batting coach from Little League to the upper echelons of professional baseball is to try to get the batters to keep their eyes on the ball as it is pitched towards them. At first, this may seem like an elementary concept, but it is an increasing problem for hitters at every level. Today, more and more batters are showing a tendency to turn their head while swinging, and are thus relying more on their peripheral vision to make contact with the ball, rather than their direct forward vision. This is considered a bad habit by most batting coaches.

Turning the head during swinging, may adversely affect the eye-hand coordination needed to hit a ball, and may also thus limit the control and the power impacted to the ball when contact is made. Furthermore, turning the head during swinging also decreases the odds of a batter getting a base hit. Batter that continue to swing at balls while turning their head may undesirably condition themselves to swing with less power and less control, and with decreased odds of making contact with the ball.

To facilitate developing the skills needed to consistently hit a ball, various methods have been employed. One method includes placing a ball on a stationary pole or tee, whereupon the batter attempts to hit the ball off the tee. Using a tee develops basic hand-eye coordination, but does not allow a batter to practice hitting a moving ball. Another method uses a ball permanently fastened to the first end of a rope, and a “pitcher” holds the second end of the rope and swings the ball around in a circle. The batter stands outside the orbit of the moving ball and attempts to hit the ball with the bat. Although this method enables a batter to hit a moving ball, this method may still enable a batter's head to turn prior to contacting the ball.

### BRIEF SUMMARY OF THE INVENTION

In one aspect, a protective helmet configured to be worn by a user is provided. The helmet includes a domed shell, a visor, and at least one blinder. The visor extends forwardly from the shell. The at least one blinder includes an upper edge, a lower edge, and a body extending therebetween. The blinder is coupled to the shell such that the blinder upper edge is between the visor and the blinder lower edge. The blinder body obstructs vision of the user between the visor and the blinder lower edge.

In another aspect of the invention, an apparatus is provided. The apparatus includes a protective helmet, and at least one blinder. The protective helmet includes a contoured shell member and a visor that extends forwardly from the shell member. The at least one blinder is coupled to the protective helmet and extends forwardly from the shell. The at least one blinder is configured to obstruct peripheral vision of a wearer of the helmet.

In a further aspect, a method for fabricating a protective helmet is provided. The method includes forming a shell configured to facilitate protectively insulating a wearer's head, extending a visor forwardly from the shell, and extending a first blinder forwardly from the shell to facilitate obstructing peripheral vision of a wearer of the helmet.

In yet another aspect of the invention, a method for instructing an individual to hit a projectile is provided. The method includes obstructing the peripheral vision of the individual, and directing the projectile towards the individual such that the individual is forced to turn his head to see the projectile to be hit.

### BRIEF DESCRIPTION OF THE DRAWINGS

FIG. 1 is a side view of a batter in position to hit a ball;

FIG. 2 is a plan view of an exemplary blinder; and

FIG. 3 is a perspective view of the blinder shown in FIG. 2 extending from an exemplary batting helmet.

### DETAILED DESCRIPTION OF THE INVENTION

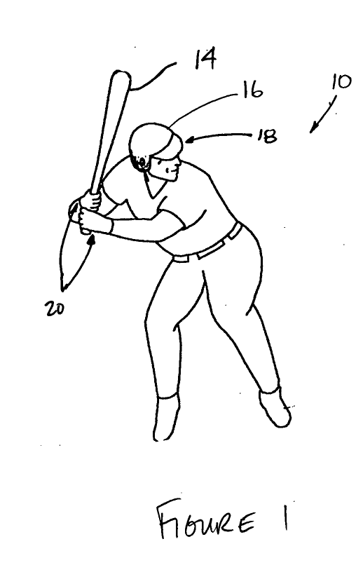

FIG. 1 is a side view of a trainee, herein referred to as batter 10 in a desired customary position and posture, also known as a stance, for hitting a projectile (not shown). In one embodiment, the projectile is a baseball. In another embodiment, the projectile is a softball. In yet another embodiment, the projectile is any object that is directed towards the individual, such that the individual may attempt to hit the object, such as occurs in sports or activities, such as, but not limited to baseball, softball, cricket, corkball, or stickball. In the exemplary embodiment, batter 10 holds a bat 14 in a ready position to swing bat 14 at the projectile. Batter 10 also wears a protective helmet or a batting helmet 16, as described in more detail below, to facilitate protecting batter 10 during batting.

More specifically, the batting stance illustrated in FIG. 1 is a desired position for batter 10 to be in to facilitate hitting the projectile directed towards himself. In the stance, the batter's weight is balanced, and his head 18 is rotated towards the projectile being directed towards him. Rotating his head 18 enables batter 10 to view the projectile as it is approaching, and thus enables batter 10 to view the approaching projectile with forward vision, rather than peripheral vision. When batter 10 swings at a pitched ball, batter 10 attempts to place his hands 20 along a swing plane that is substantially parallel to the line of travel of the ball, and to move his hands 20 in a generally circular motion around his body and along the swing plane for as long as possible to facilitate the possibility of bat 14 making contact with the projectile. More specifically, as batter 10 swings at the ball, if batter 10 maintains eye contact with the ball during the swing, eye-hand coordination may be enhanced, which facilitates batter 10 making contact with the ball.

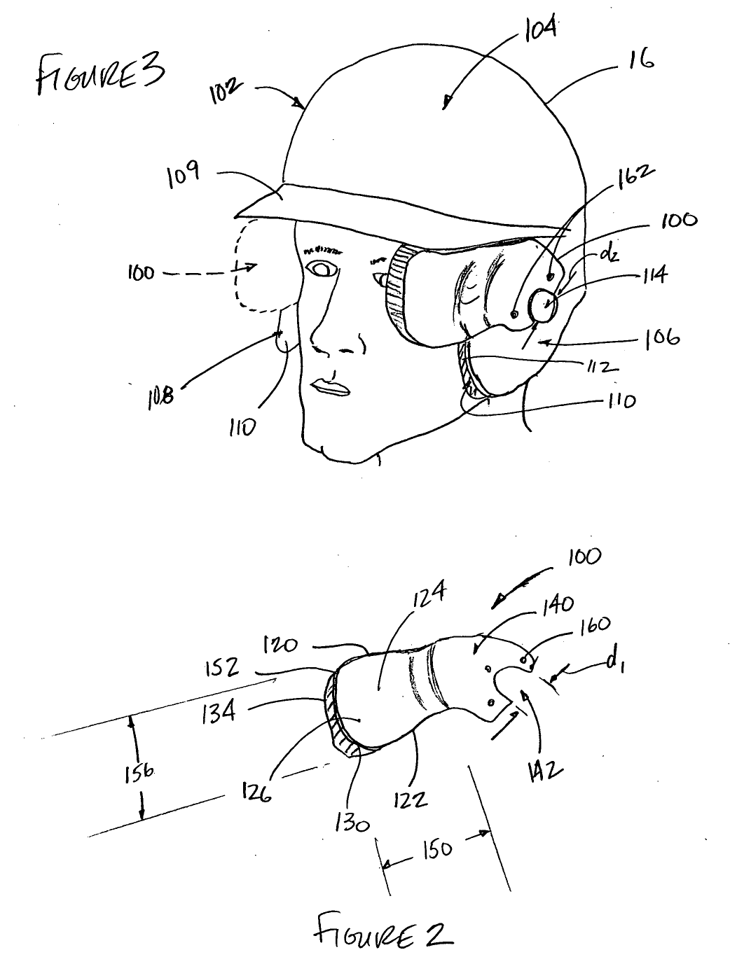

FIG. 2 is a plan view of an exemplary blinder 100. FIG. 3 is a perspective view of blinder 100 coupled to batting helmet 16. Helmet 16 is known and generally includes a head-covering assembly 102 which includes a top portion 104 and a pair of side panels 106 and 108 that extend downward from top portion 104. Helmet 16 also includes a visor 109. In an alternative embodiment, helmet 16 includes only one side panel 106 or 108 which extends downward from top portion 104 along a side of helmet 16 that will be closest to a pitcher during batting. For example, a right-handed batter may wear a helmet including only one panel 106 extending downward to facilitate covering a left-side of batter's head 18.

Panels 106 and 108 are mirrored images of each other, and are oppositely disposed with respect to helmet 16. Each panel 106 and 108, as well as top portion 104, includes an inner surface 110 that is insulated with an insulating material or padding 112 that facilitates dissipating impact force to induced through helmet 16 to batter's head 18. Moreover, each panel 106 and 108 includes an opening 114 extending therethrough, and positioned to be adjacent an ear of batter 10 when helmet 16 is worn. Top portion 104 and side panels 106 and 108 are fabricated from a rigid impact-resistant material that facilitates protecting batter's head 18.

Helmet visor 109 extends forwardly from helmet top portion 104 and facilitates shielding batter's eyes from the elements, as well as providing protection against contact by a ball.

Blinder 100 includes an upper edge 120, a lower edge 122, and a body 124 extending therebetween. In the exemplary embodiment, body 124 is substantially rectangular-shaped. Alternatively, blinder body 124 may have any shape that permits blinder 100 to function as described herein. Blinder 100 also includes an outer surface 126 and an opposite inner surface 130. An insulating material or padding 134 extends over at least a portion of inner surface 130. In one embodiment, insulating material 134 is the same as insulating material 110. Outer surface 126 is fabricated from a rigid impact-resistant material that facilitates protecting batter's head 18. In one embodiment, blinder 100 is fabricated substantially identically to helmet 16 and includes the same materials as helmet 16.

Blinder 100 is contoured and includes a fastening portion 140. In the exemplary embodiment, insulating material 134 does not extend over fastening portion inner surface 134. More specifically, fastening portion 140 extends substantially rearward from blinder body 124 and includes a recess 142. Recess 142 has a diameter d₁ that is larger than a diameter d₂ of helmet ear opening 114, such that when blinder 100 is coupled to helmet 16, helmet ear opening 114 remains unobstructed. In an alternative embodiment, ear opening 114 is non-circular, and recess 142 is sized such that when blinder 100 is coupled to helmet 16, helmet ear opening 114 remains unobstructed. Blinder 100 extends outwardly a distance 150 from fastening portion 140 to a forward edge 152, and has a width 156 measured between edges 120 and 122. Distance 150 and blinder width 156 are variably selected to enable blinder 100 to function as described herein.

In the exemplary embodiment, blinder fastening portion 140 includes at least one fastener opening 160 sized to receive a fastener 162 therethrough. In an alternative embodiment, blinder 100 does not include any fastener openings 160. More specifically, in the exemplary embodiment, helmet 16 includes at least one fastener opening (not shown) extending therethrough and adjacent ear opening 114. Such helmet openings are known and may enable a face guard and/or a chinstrap to be coupled to helmet 16.

During assembly, in the exemplary embodiment, blinder 100 is coupled to helmet 16 with fastener 162. In an alternative embodiment, blinder 100 is formed integrally with helmet 16 during fabrication of helmet 16. In another embodiment, blinder 100 is coupled to helmet 16 with an adhesive material. More specifically, fastener 162 extends through fastener opening 160 and the helmet fastener opening to secure blinder 100 to helmet 16. In one embodiment, blinder 100 is removably coupled to helmet 16. In another embodiment, blinder 100 is fixedly secured to helmet 16. Blinder 100 is coupled to helmet 16 such that fastening portion inner surface 130 is between helmet 16 and blinder outer surface 126. In an alternative embodiment, blinder 100 is coupled to helmet 16 such that fastening portion outer surface 126 is against helmet inner surface 109 and between helmet inner surface 109 and fastening portion inner surface 130.

In the exemplary embodiment, because blinder 100 is contoured, when blinder 100 is coupled to helmet 16, blinder body extends from, and substantially follows a contour of, helmet panel 106 and/or 108. More specifically, blinder 100 is coupled to helmet 16 such that blinder upper edge 120 is against helmet visor 109, and such that blinder body 124 extends downwardly from edge 120 to blinder lower edge 122.

During use, when helmet 16 is worn, blinder 100 facilitates obstructing the peripheral vision of batter 10 when wearing helmet 16. As such, when batter 10 assumes a stance for hitting a ball, blinders 100 force batter 10 to rotate head 18 and use direct forward vision to see the approaching ball. As the ball gets closer, blinder 100 forces batter 10 to continue to rotate head 18 to maintain sight of the approaching projectile. When batter swings at a pitched ball, blinder 100 forces batter to rotate head 18 to maintain eye contact with the projectile during the swing and contact with the ball. Over time, blinder 100 facilitates batter 10 developing and/or enhancing eye-hand coordination and muscle memory which facilitates increasing a likelihood of success in consistently contacting the ball, without sacrificing swing power and/or swing control. Furthermore, because blinders 100 force batter 10 to rotate head 18 towards the approaching projectile, blinders 100 also facilitate reducing external distractions of surroundings to batter 10.

The above-described batting helmet is cost-effective and reliable. The helmet includes at least one blinder that extends forwardly from the helmet to facilitate obstructing and/or eliminating a batter's peripheral vision towards a pitcher throwing a ball. More over, the blinders force batters to rotate their heads to maintain eye contact with the ball using forward vision. Over time, continued use of the blinders facilitates a batter developing and/or enhancing eye-hand coordination, and muscle memory to increase the likelihood of consistently hitting the projectile, thus improving batter's batting average and on-base percentage. As a result, the blinders facilitate improving the offensive statistics of a batter in a cost effective and reliable manner.

Exemplary embodiments of batting helmets are described above in detail. The helmets are not limited to the specific embodiments described herein, but rather, components of each helmet may be utilized independently and separately from other components described herein. Each blinder component can also be used in combination with other blinder components

While the invention has been described in terms of various specific embodiments, those skilled in the art will recognize that the invention can be practiced with modification within the spirit and scope of the claims.

What is claimed is:

1. A protective helmet configured to be worn by a user, said helmet comprising:
a domed shell;
a visor extending forwardly from said shell; and
at least one blinder comprising an upper edge, a lower edge, and a body extending therebetween, said blinder coupled to said shell such that said blinder upper edge between said visor and said blinder lower edge, said blinder body obstructing vision of the user between said visor and said blinder lower edge.

2. A helmet in accordance with claim 1 wherein said at least one blinder further comprises an inner surface and an outer surface, said at least one blinder coupled to said shell such that said blinder inner surface between said shell and said blinder outer surface, said blinder inner surface comprising padding.

3. A helmet in accordance with claim 1 wherein said at least one blinder further comprises an inner surface and an outer surface, said blinder coupled to said shell such that said blinder outer surface between said shell and said blinder inner surface, said blinder inner surface comprising padding.

4. A helmet in accordance with claim 1 wherein said shell comprises a panel comprising an ear opening, said helmet configured to be worn such that said ear opening adjacent an ear of the user, said at least one blinder coupled to said shell panel.

5. A helmet in accordance with claim 4 wherein said at least one blinder coupled to said shell panel such that said ear opening is unobstructed.

6. A helmet in accordance with claim 1 wherein said at least one blinder removably coupled to said shell.

7. A helmet in accordance with claim 1 wherein said at least one blinder fixedly coupled to said shell.

8. A helmet in accordance with claim 1 wherein said at least one blinder formed integrally with said shell.

9. A helmet in accordance with claim 1 wherein said at least one blinder further comprises a first blinder and a second blinder, said first blinder a mirror image of said second blinder and coupled to a first side of said domed shell, said second blinder coupled to a second side of said domed shell.

10. An apparatus comprising:
a protective helmet comprising a contoured shell member and a visor extending forwardly from said shell member; and
at least one blinder coupled to said protective helmet and extending forwardly from said shell, said at least one blinder configured to obstruct peripheral vision of a wearer of said helmet.

11. Apparatus in accordance with claim 10 wherein said protective helmet further comprises a panel portion configured to extend over an ear of the wearer, said at least one blinder coupled to said helmet panel portion.

12. Apparatus in accordance with claim 10 wherein said protective helmet further comprises an opening extending therethrough, said opening adjacent an ear of the wearer, said at least one blinder coupled to said helmet adjacent said opening such that said opening is unobstructed by said at least one blinder.

13. Apparatus in accordance with claim 10 wherein said at least one blinder comprises an inner surface and an outer surface, said at least one blinder coupled to said helmet such that said blinder inner surface between said shell and said blinder outer surface.

14. Apparatus in accordance with claim 10 wherein said at least one blinder further comprises an inner surface and an outer surface, said blinder coupled to said shell such that said blinder outer surface between said shell and said blinder inner surface.

15. Apparatus in accordance with claim 10 wherein said at least one blinder is removably coupled to said helmet by at least one fastener.

16. Apparatus in accordance with claim 10 wherein said at least one blinder fixedly coupled to said helmet.

17. A helmet in accordance with claim 10 wherein said at least one blinder formed integrally with said shell.

18. A helmet in accordance with claim 10 wherein said at least one blinder comprises at least a first blinder coupled to a first side of said helmet, and at least a second blinder coupled to a second side of said helmet, opposite said first blinder

19. A helmet in accordance with claim 19 wherein said at least one blinder is insulated.

20. A method for fabricating a protective helmet, said method comprising:
forming a shell configured to facilitate protectively insulating a wearer's head;
extending a visor forwardly from the shell; and
extending a first blinder forwardly from the shell to facilitate obstructing peripheral vision of a wearer of the helmet.

21. A method in accordance with claim 21 wherein extending a first blinder forwardly from the shell further comprises extending the first blinder from the shell such that the first blinder is adjacent the visor.

22. A method in accordance with claim 21 wherein extending a first blinder forwardly from the shell further comprises removably coupling the first blinder to the shell with at least one fastener.

23. A method in accordance with claim 21 wherein extending a first blinder forwardly from the shell further comprises forming the first blinder integrally with the shell.

24. A method in accordance with claim 21 wherein extending a first blinder forwardly from the shell further comprises extending the first blinder from the shell such that an inner surface of the first blinder is between the shell and an outer surface of the first blinder.

25. A method in accordance with claim 21 wherein extending a first blinder forwardly from the shell further comprises extending the first blinder from the shell such that the blinder is between the wearer and at least a portion of the helmet.

26. A method in accordance with claim 21 wherein extending a first blinder forwardly from the shell further comprises fixedly coupling the first blinder to the shell with at least one fastener

27. A method in accordance with claim 21 further comprising extending a second blinder forwardly from the shell to facilitate obstructing peripheral vision of a wearer of the helmet, wherein the second blinder is a mirror image of, and is positioned opposite the first blinder.

28. A method for instructing an individual to hit a projectile, said method comprising:
obstructing the peripheral vision of the individual; and
directing the projectile towards the individual such that the individual is forced to its head to see the projectile to be hit.

29. A method in accordance with claim 28 wherein obstructing the peripheral vision of the individual further comprises forcing the individual to wear a protective helmet that includes a first blinder that extends forwardly from the helmet to facilitate obstructing the peripheral vision of the individual.

30. A method in accordance with claim 29 wherein forcing the individual to wear a protective helmet that includes a first blinder further comprises forcing the batter to wear a protective helmet that also includes a second blinder that extends forwardly from the helmet to facilitate obstructing the peripheral vision of the batter, wherein the second blinder is a mirror image of, and is positioned opposite the first blinder.

31. A method in accordance with claim 29 wherein forcing the individual to wear a protective helmet that includes a first blinder further comprises forcing the batter to wear a protective helmet that includes a first blinder that is formed integrally with the helmet.
